(19) United States
(12) Patent Application Publication
(10) Pub. No.: US 2019/0053516 A1
(43) Pub. Date: Feb. 21, 2019

(54) SYSTEM AND METHOD FOR UTILIZING A TUBE UNIT TO MAKE A FROZEN CONFECTION

(71) Applicants: Robert McDaniels, Staten Island, NY (US); Ross Macey, Brooklyn, NY (US)

(72) Inventors: Robert McDaniels, Staten Island, NY (US); Ross Macey, Brooklyn, NY (US)

(21) Appl. No.: 15/679,331

(22) Filed: Aug. 17, 2017

(51) Int. Cl. A23G 9/48; F21L 4/02

(52) U.S. Cl. CPC A23G 9/485; F21Y 2115/10; F21L 4/02

(57) ABSTRACT

A method of making a frozen confection includes: providing a tube unit device; filling an opening of the tube unit device with a plurality of liquids and sealing the opening of the tube unit device; placing the tube unit device in a tray mold; forming a frozen confection around the tube unit device, wherein the tube unit device is separated from the frozen confection by a wall of the tube unit device; and configuring the tube unit device to initiate a light show while simultaneously being surrounded by the frozen connection.

### CROSS REFERENCE TO RELATED APPLICATION

This non-provisional patent application is a continuation in part application that claims priority to a U.S. Non-Provisional patent application Ser. No. 14/576,305, filed on Dec. 19, 2014 which is incorporated herein by reference.

### FIELD OF THE INVENTION

The present invention relates to a system and method for utilizing a tube-unit device to make a frozen confection.

### BACKGROUND OF THE INVENTION

Generally, ice cream and other types of frozen desserts, frozen confections such as Popsicles® have been enjoyed by people all over the world for a long time. Popsicles were invented back in the 1920's and since then there's been many variations on the original Popsicles including name brand treats such as the Fudgesicle®; Creamsicle® etc. Also, because of advances in manufacturing technology and food science there have been multi-colored, multi-flavored, multi-textured, low fat, low calorie and other types of Popsicles.

In order to enhance the experience of enjoying a Popsicle, some individuals may desire a refreshing alcoholic beverage with their frozen confection that doesn't conflict with a regular flavored frozen confection, but this type of frozen confection hasn't been developed. Thus, there is a need for a frozen confection that includes the refreshing alcoholic beverage that doesn't conflict with the regular flavored frozen confection.

### SUMMARY OF THE INVENTION

The present invention has been accomplished in view of the above-mentioned technical background, and it is an object of the present invention to provide a method and system of making frozen confections.

A method of making a frozen confection, comprising: providing a tube unit device; filling atop opening of the tube unit device with a plurality of liquids and sealing the opening of the tube unit device; placing the tube unit device in a tray mold; and to forming a frozen confection around the tube unit device, wherein the tube unit device is separated from the frozen confection by a wall of the tube unit device.

### BRIEF DESCRIPTION OF THE DRAWINGS

These and other advantages of the present invention will become more apparent as the following description is read in conjunction with the accompanying drawings, wherein:

FIGS. 1A and 1B show a top portion of a Frozen confection mold and a bottom portion of a Frozen confection mold in accordance invention;

FIG. 1C is a top view of the top portion of a Frozen confection mold affixed to the bottom portion of the Frozen confection mold in accordance with the invention;

FIG. 1D is an upward view of the top portion of the frozen confection mold of FIG. 1A in and a bottom portion of the Frozen confection mold of FIG. 1A in accordance with the invention;

FIG. 1E is a view of the bottom portion of the Frozen confection mold in accordance with the invention;

FIG. 1F is a top view of the top portion of the Frozen confection mold tightly clamped down onto the bottom portion of the Frozen confection mold in accordance with the invention;

FIG. 2 shows an illustration of a tube unit device;

FIG. 3 shows another embodiment of an illustration of the tube unit device;

FIG. 4 is a flowchart describing how the tube unit device is utilized;

FIG. 5 shows the tube unit device surrounded by a frozen confection; and

FIG. 6 shows another embodiment of the tube unit surrounded by a frozen confection.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

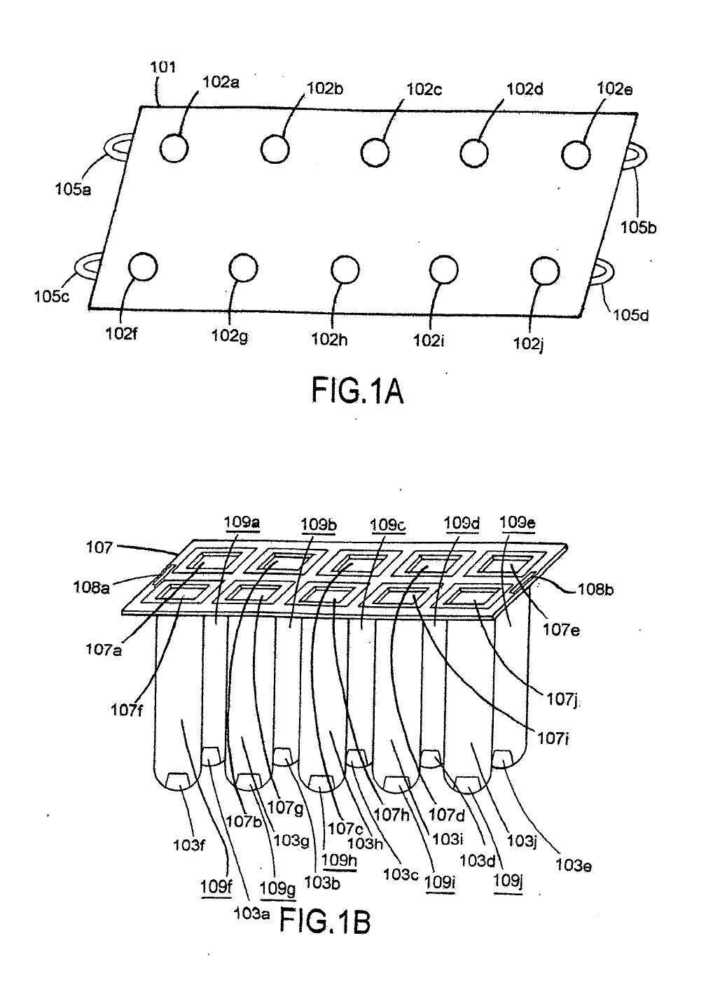

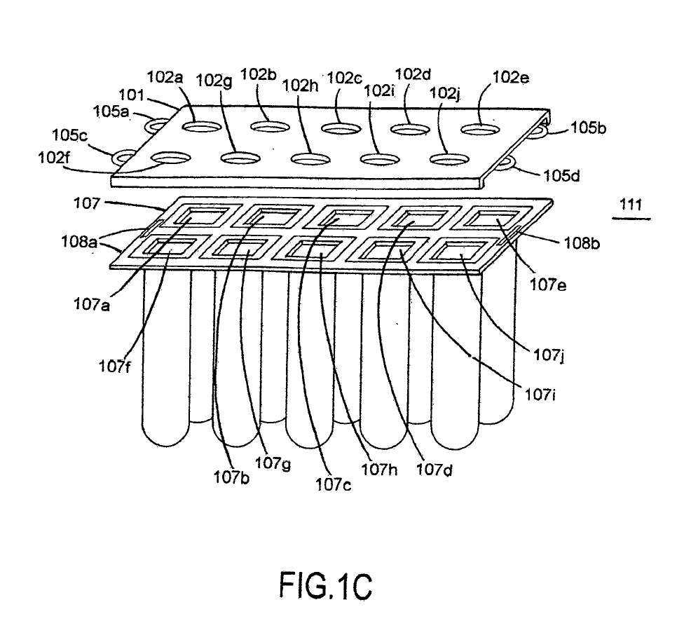

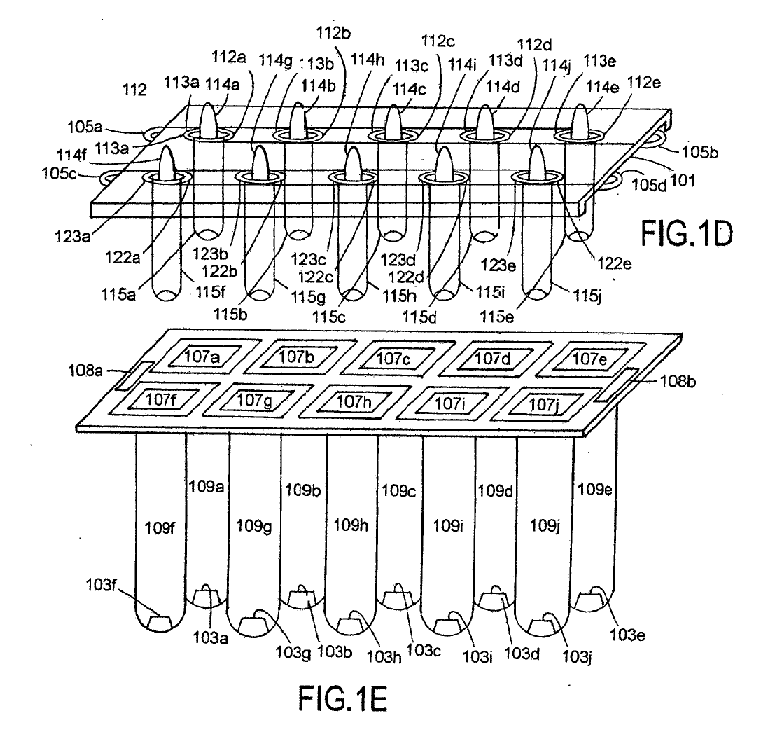

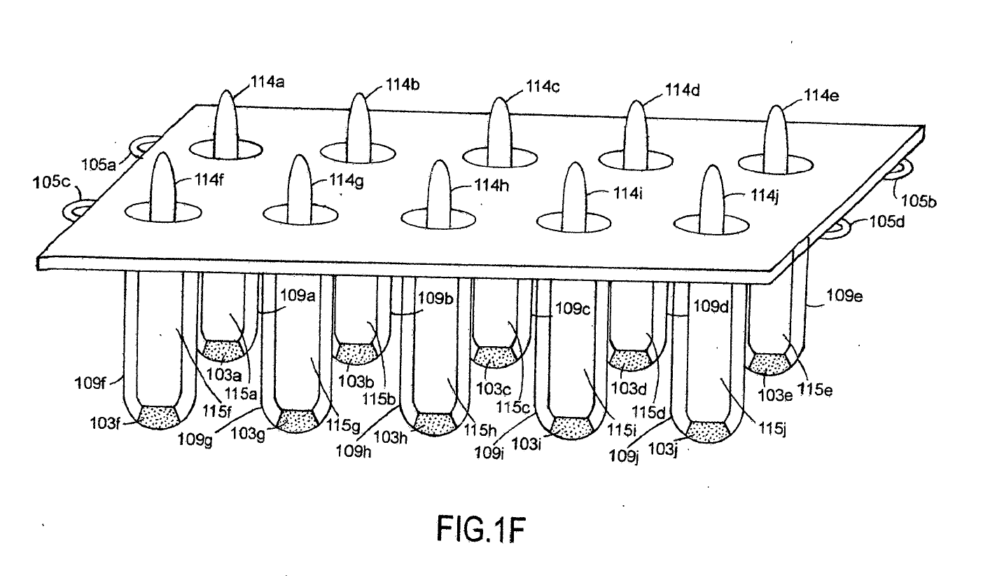

FIGS. 1A and 1B show a top portion of a Frozen confection tray mold and a bottom portion of die Frozen confection tray mold in accordance with the invention. FIG. 1A shows a top portion 101 of a typical frozen confection tray mold: Top portion 101 includes slot 102a, slot 102b, slot 102c, slot 102d, slot 102e, slot 102f, slot 102g, slot 102h, slot 102i and slot 102j (slots 102 a-j). The top portion 101 is made of stainless steel and has length in the range of 6 inches to 1 foot or more, preferably 9 inches and has a width in the range of 4 to 10 inches, preferably 4 inches. Top portion 101 has a thickness in a range of ¼ inch to ¾ inch, preferably ½ inch. Each of the slots 102a-j have an opening where a plurality of stems 114a, 114b, 114c, 114d, 114e, 114f, 114g, 114h, 114i and 114j of a plurality of shot pops 115a-j can protrude out from it. Also, top portion 101 includes locking clips 105a, 105b, 105c and 105d on the left and right side of the top portion 101 in order to prevent the movement of the plurality of shot pops 115a-j (FIG. 1F).

At FIG. 1B, a bottom portion 107 of the popsicle tray mold includes slot 107a, slot 107b, slot 107c, slot 107d, slot 107e, slot 107f, slot 107g, slot 107h, slot 107i and slot 107j are respectively on top of a plurality of bottom compartments 109a, 109b, 109c, 109d, 109e, 109f, 109g, 109h, 109i and 109j. The bottom portion 107 is made of stainless steel and has a length in the range of 6 inches to 1 foot or more, preferably 9 inches and has a width in the range of 4 to 10 inches, preferably 4 inches. Bottom portion 107 has a thickness in a range of ¼ inch to ¾ inch, preferably ½ inch. FIG. 1C is shows the top portion 101 on top of the bottom portion 107 to form the Popsicle tray mold 111. The top portion 101 of slot 1014 slot 102b, slot 102c, slot 102d, slot 102e, slot 102f, slot 102g, slot 102h, slot 102i and slot 102j fits or is respectively disposed over a top of the bottom portion 107 of the popsicle tray mold 111 on slot 107a, slot 107b, slot 107c, slot 107d, Sot 107e, slot 107f, slot 107h, 107i and slot 107j. Top portion 101 with locking clips 105a, 105b, 105c and 105d clamps down on respective clip receptors 108a and 108b to tightly hold the top portion 101, of Popsicle fray mold 111 onto the bottom portion 107. The popsicle tray mold 111 may have any type of shape, such as a pear, shape of a bat, shape of animated figure or any type of figure. The plurality of stoppers 103a, 103b, 103; 103d, 103e, 103f, 103g, 103h, 103i and 103j are disposed inside the plurality of bottom compartments 109a, 109b, 109c, 109d, 109e, 109f, 109g, 109h, 109i and 109j.

FIG. 1D shows a view of the bottom of the top portion of the frozen confection mold of FIG. 1A. Top portion 101 has the clocking clip 105a that pulls an elongated metal rod 112 east, where the metal rod 112 has flat curvature hooks 112a, 112b, 112c, 112d, 112e. Curvature hooks 112a-e may be referred to as locking arms. The elongated metal rod 112 has a length in the range of 6 to 12 inches and the curvature hooks 112a-e has a length in the range of ½ inch to 1 inch. The locking clip 105a with the metal rod 112 pulls the curvature hooks 112a, 112b, 112c, 112d and 112e east as they are placed around the underside of respective slots 102a, 102b, 102c, 102d and 102e, which works with the locking clip 105b to hold the respective stems 114a-e. The locking clip 105b pulls an elongated metal rod 113 west, where the metal rod 113 has flat curvature hooks 113a, 113b, 113c, 113d and 113e that pulls the respective stems 114a-e west. Curvature hooks 113a-e may be referred to as locking arms. The elongated metal rod 113 has a length in the range of 6 to 12 inches and the curvature hooks 113a-e has a length in the range of ½ inch to 1 inch. The eastward pull of the locking clip 105a with the metal rod 112 onto the respective stems 114a-e and the westward pull of the locking clip 105b with the metal rod 113 onto the respective stems 114a-e keeps the stems 114a-e tightly in place and locks the stems 114a-e in place in the bottom portion 107 of the popsicle tray mold 111. (FIG. 1E)

FIG. 1F shows the top portion fully covering the bottom portion of the Popsicle tray mold. The respective lock clips 105a and 105b secures the stems 114a-e of the respective plurality of shot pops 115a-e within the bottom portion 107 of popsicle tray mold 111 while respective locks 105c and 105d secures the stems 114f-j of the respective plurality of shot pops 115f-j in the bottom portion of 107 of the popsicle tray mold 111. Stems 114a-j are tightly held by the lock clips 105a, lock clip 105b, metal rod 112, metal rod 113, lock clip 105c, lock clip 105d, metal rod 122 and metal rod 123 in the bottom portion 107 of the popsicle tray mold 111 to prevent the stems 114a-j from moving within the bottom portion 107.

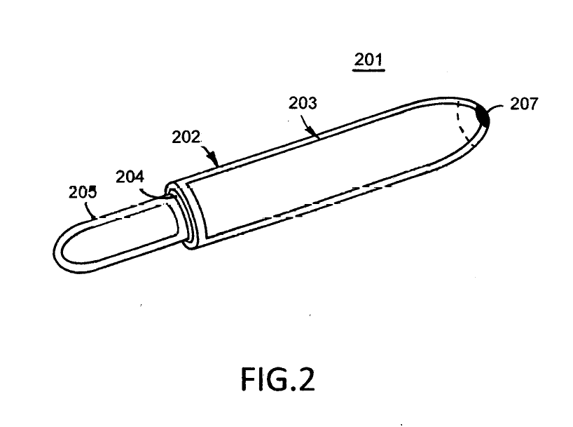

FIG. 2 is an illustration of a tube unit device. The tube unit device is also known as a Boozypop® unit that is in some ways similar to the shot pop described to above. The Boozypop unit is a registered trademark of Indigo Ice Corp, which is described as an alcoholic cocktail in the form of a frozen pop. This Boozypop unit 201 is a translucent food grade plastic device that has a top portion 202 that has an outer wall 203, which houses 1-3 fluid ounces of liquid and a handle 205 connected to a bottom 209 of the top portion 202. Top portion 202 also had an opening 207 or mouth 207 at its top that has a concaved opening approximately 10-15 mm wide, preferably 13 mm wide. An actual thickness Of a wall 203 of the top portion 202 is in the range of 450-550 mm, preferably 0.508 mm. The liquid housed in the top portion 202 may be alcohol, spirits, cordials, any type of liquids or ant combination thereof. The entire Boozypop unit 201 is approximately 150-155 mm long, preferably 152 mm long and 15-25 mm wide, preferably 20 mm wide. Top portion 202 that holds the liquid is the range of 100-105 mm, preferably 101 mm. Handle 205 has a length in the range of 45-55 mm, preferably 51 mm long.

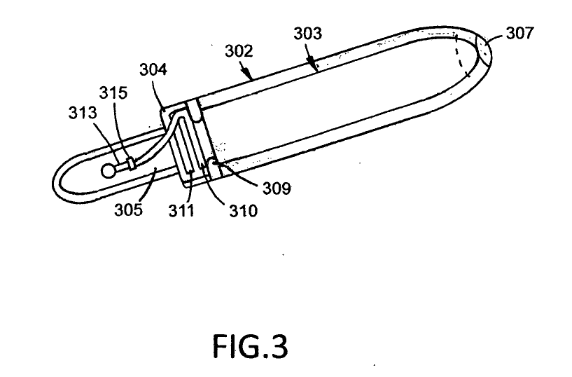

FIG. 3 is another embodiment of the tube unit device of FIG. 2. This tube unit device may be referred to as a Boozypop enhanced unit 301 is also a translucent, food grade plastic device that also incorporates two elements. Boozypop unit 301 includes a top portion 302, similar to top portion 202 and a handle 305 similar to handle 205 of Boozypop unit 201. Handle 305 also includes a slit 315 where a tab pull 313 is inserted through to keep it place on the handle 305. A bottom portion 304 also includes 1 separate compartment tot is separated from the liquid in the tube unit 301, which contains 4 sealed items: light emitting diode (LED) 309, paper 310, a coin sized battery 311 and a tab pull 313 connected to paper 310. The battery 311 is on the bottom while the paper 310 and LED 309 sits on top. LED 309 have 5-6 multi-colored diodes that include the colors yellow, green, orange, red, blue, purple etc. The overall length of the Boozypop unit 301 is in the range of 160-180 mm, preferably 165 mm in height and 15-30 mm width, preferably 20 mm width. Top portion 301, which is cylindrical that houses the liquid content (spirits, alcohol, cordials and plurality of liquids) has a length in the range of 105 mm to 120 mm, preferably 114 mm and the width is in the range of 15-30 mm, preferably 20 mm wide. LED 309 and battery 311 are separated by a paper 310 connected to a pull tab 313 so when the pull tab 313 is pulled the paper is removed then the LED 309 is connected to the battery 311 tot causes the LED 309 to emit 5 to 6 different diodes having any color, such as red, green, yellow orange, blue, purple etc. within a frozen confection Boozypop. Paper 310 is a non-conductive paper or non-conductive sheet, which doesn't conduct any electricity. LED 309 band battery 311 are sourced from generic companies that produce small circuitry. Battery 311 has 3-5volts, preferably it is a 3.6 volt coin shaped capacitor that can fit in between LED 309 and paper 310 within the diameter of the boozy pop unit 301. LED 309 may be referred to as a lighting device. The light features of the LED 309 are emitted when a person pulls on tab 313 thereby pulling the paper 310 to remove from in between the LED 309 and battery 311 allowing the LED 309 to connect with battery 311 that conducts electricity causing the multi-colored diodes on LED 309 to become illuminated or light up. A mouth 307 at top portion 303 at its top has a concaved opening approximately 10-15 mm wide, preferably 13 mm wide 307 similar to mouth or opening 207.

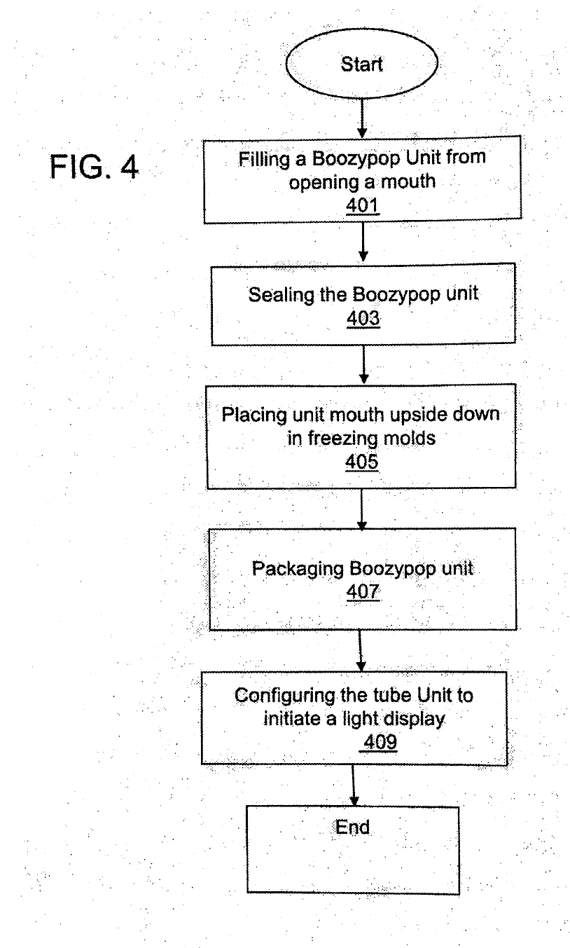

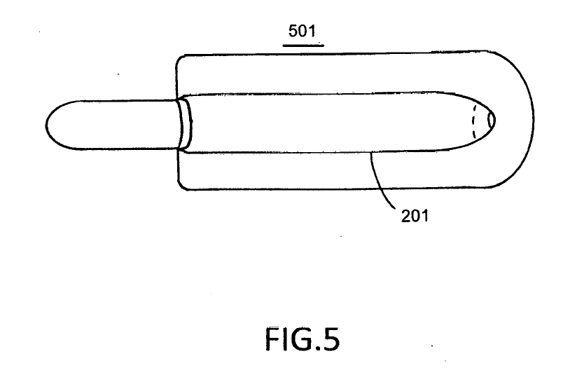

FIG. 4 shows a flow-chart of how the tube units are utilized to form frozen confections Boozypop. The Boozypop Unit-201 (FIG. 2) and 301 (FIG. 3) arrive already Manufactured to design specifications by a factory that specializes in food-grade plastics: At block 401, the openings 207 of Boozypop unit 201 and the mouth 207 and mouth 307 of Boozypop units 201 and 301 are opened and filled with a liquor (spirits, alcohol, cordials or combinations thereof). Next, at block 403 the opening 207 and mouth 307 are then sealed by a typical sealing process, such as via foil induction where foil discs are placed over the openings 207 and mouth 307.

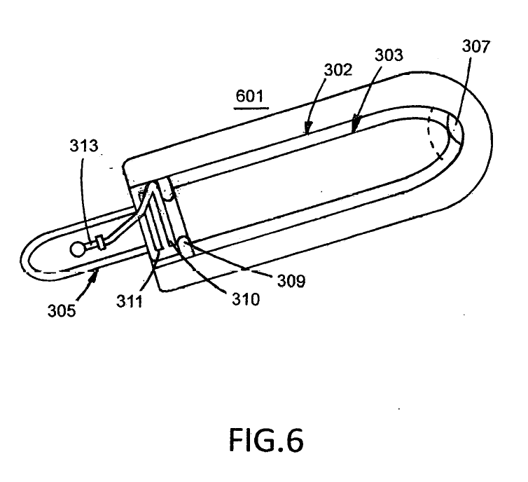

At block 405, a heating element is utilized to create the airtight seal necessary at the opening 207 and mouth 307. Next, at block 405 the filled boozy pop units 201 and 301 are then placed upside down in a tray mold which are filled with liquid confections, then the mold is frozen. Next, at block 407 after the molds are frozen (as shown in FIGS. 5 and 6, you have a frozen ice pop or frozen confection Boozypop on the outside and beneath the surface the Boozypop unit 201 or 301 are filled With the liquid (alcohol, cordials, spirit or combination thereof) as shown in FIGS. 5 and 6. The Boozypop unit 201 or 301 are separated from the frozen confection 501 and frozen confection 601 by its walls 203 and 303 discussed above so the liquids of the Boozypop units 201 and 301 do not come into contact with frozen confections 501 and 601 because of the wall surrounding Boozypop units 201 and 301 to keep the liquor separate from the frozen confections 501 and 601. The frozen confection may have color found in typical ice pops, such as red, blue, yellow, rainbow, clear etc. If for example the frozen confection is clear then the Boozypop units 201 and 301 would be readily shown. In the case of clear ice as a confection for Boozypop unit 301, then the LED 309 will be shown through the frozen confection 601. (FIG. 6) Because the alcohol of certain proofs do not freeze, nor does the liquid in the tube ever mix with the frozen confection it is basically a paradox on you fingertips, a solid with a liquid center, and they are housed in 1 unit. For FIG. 6, the Boozypop Unit 301 includes LED 309, paper 310 and battery 311 with pull tab 313 so that when the pull tab 3131s pulled LED 309 is illuminated through tube unit 301, such as clear ice for the frozen confection 601 a dazzling effect is created, this could ignite, any party; sporting event or moment because LED 309 is programmable to emit light from the Boozypop enhance unit device 301.

This invention provides a simple way to make a frozen confection by utilizing a tube unit device. Any type of liquor or plurality of liquids are poured into an opening of the tube unit device, where the liquor or the plurality of liquids are kept in the tube unit. The opening is then sealed. The tube unit is then inserted into a tray mold where the outside cylindrical portion is surrounded by the frozen confection. The tube unit is filled with liquor so that a user can open the opening to get the liquor or eat the frozen confection. Also, the tube unit device can have LEDs that cause it to light up to programmable lights.

What is claimed is:

1. The method of making a frozen confection, comprising:
providing a tube unit device;
filling an opening of the tube unit device with a plurality of liquids and sealing the opening of the tube unit device;
placing the tube unit device in a tray mold; and
forming a frozen confection around the tube unit device, wherein the tube unit device is separated from the frozen confection by a wall of the tube unit device.

2. The method of claim 1, further comprising configuring the tube unit device to initiate a light show while simultaneously being surrounded by the frozen connection.

3. The method of claim 2, wherein the light show display is emitted by configuring a battery with a lighting device.

4. The method of claim 1, Wherein the plurality of liquids is from the group comprising spirits, alcohol, cordials and Plurality of liquids.

5. The method of claim 1 Wherein the tube unit device is made of a food grade plastic

6. A tube unit device comprising;
a top portion and a bottom portion wherein the bottom portion is connected to a handle;
the top portion is configured to receive a plurality of liquids;
the top portion includes an opening to receive and hold the plurality of liquids;
a sealer to close the opening;
wherein the tube unit device is separated from the frozen confection by a wall of the tube unit device.

7. The tube unit device of claim 6 further comprising a lighting device affixed to the bottom portion, wherein a battery is placed on top of the lighting device, wherein the battery is configured to light up the lighting device.

8. The tube unit of claim 7, wherein the lighting device is a light emitting diode.

9. The tube unit of claim 7, wherein the battery is a coin sized battery.

10. The tube unit of claim 7, wherein the battery is a capacitor.
